(19) United States
(12) Patent Application Publication
(10) Pub. No.: US 2009/0285440 A1
(43) Pub. Date: Nov. 19, 2009

(54) Electroacoustic tranducing device

(75) Inventors: Hideo Yuasa, Shandong (CN); Hidenori Motonaga, Shandong (CN); Katsunari Fujita, Shandong (CN)

Correspondence Address: BACON & THOMAS, PLLC, 625 SLATERS LANE, FOURTH FLOOR, ALEXANDRIA, VA, 22314-1176, US

(73) Assignee: Hosiden Corporation, Osaka (JP)

(21) Appl. No.: 12/453,497

(22) Filed: May 13, 2009

(30) Foreign Application Priority Data
May 13, 2008 (JP) 2008-125473

(51) Int. Cl. H04R 1/00

(52) U.S. Cl. 381/412

(57) ABSTRACT

In an electroacoustic transducing device having: a magnetic circuit 21 having a yoke 12, a magnet 18, and a pole piece 20; a vibration system 5 having a diaphragm 6, a voice coil 8, and a diaphragm ring 1; and a frame 9 which holds the magnetic circuit and the vibration system, an outer peripheral portion of the diaphragm being fixed to an outer peripheral portion of the frame through the diaphragm ring, the voice coil being placed in a magnetic gap 19, and the diaphragm ring is formed into an L-like section shape. The electroacoustic transducing device can be thinned by the diaphragm ring which is thin, light in weight, and strong. When the shape of a diaphragm bonded face of the diaphragm ring is changed while the shape of receiving face 16 of the frame remains unchanged, variations can be provided to the shape of the diaphragm.

### TECHNICAL FIELD

The present invention relates to an electroacoustic transducing device such as a small and thin speaker or receiver to be used in a portable telephone or the like.

### BACKGROUND ART

Conventionally, an electroacoustic transducing device is known which comprises: a magnetic circuit having a yoke, a magnet, and a pole piece; a vibration system having a diaphragm, a voice coil, and a diaphragm ring configured by a planar ring that is placed in a plane perpendicular to the axis of the voice coil; and a frame that holds the magnetic circuit and the vibration system, and in which an outer peripheral portion of the diaphragm is fixed to that of the frame through the diaphragm ring, and the voice coil is placed in a magnetic gap (see Patent Literature 1).

### PRIOR ART LITERATURE

### Patent Literature

[Patent Literature 1] Japanese Patent Application Laying-Open No. 2003-264890

### SUMMARY OF THE INVENTION

### Problems to be Solved by the Invention

In the diaphragm ring configured by the planar ring that is placed in a plane perpendicular to the axis of the voice coil, however, a large thickness is required in order to ensure the strength. When the shape of the diaphragm is to be changed, it is necessary to change not only the inner shape of the diaphragm ring but also the outer shape. In accordance with the change, also a receiving face of the frame must be changed, with the result that variations are hardly provided to the shape of the diaphragm.

### Means for Solving the Problems

Therefore, the electroacoustic transducing device of the invention is an electroacoustic transducing device comprising: a magnetic circuit having a yoke, a magnet, and a pole piece; a vibration system having a diaphragm, a voice coil, and a diaphragm ring; and a frame which holds the magnetic circuit and the vibration system, an outer peripheral portion of the diaphragm being fixed to an outer peripheral portion of the frame through the diaphragm ring, the voice coil being placed in a magnetic gap, wherein the diaphragm ring has: a planar ring portion which is placed in a plane perpendicular to an axis of the voice coil; and a wall portion which is formed by bendingly extending an outer peripheral edge of the planar ring portion at a bending angle of about 90 degrees in one direction, and the diaphragm ring is formed into an L-like section shape.

According to the diaphragm ring having the L-like section shape, it is not necessary to have a large thickness. Even when the shape of a receiving face of the frame remains unchanged, moreover, a face to which the diaphragm is to be bonded (hereinafter, the face is referred to as the diaphragm bonded face) can be changed.

### EFFECTS OF THE INVENTION

As described above, in the electroacoustic transducing device of the invention, the diaphragm ring which is thin, light in weight, and strong enables the device to be easily thinned. When the diaphragm bonded face of the diaphragm ring is changed while the shape of the receiving face of the frame remains unchanged, variations can be provided to the shape of the diaphragm.

### BRIEF DESCRIPTION OF THE DRAWINGS

FIG. 1 is a perspective view of a diaphragm ring in an embodiment of the invention.

FIG. 2 is a half-sectional view of a vibration system in the embodiment of the invention.

FIG. 3 is a perspective view of a frame in the embodiment of the invention.

FIG. 4 is a mid-sectional view of an electroacoustic transducing device in the embodiment of the invention.

FIG. 5 is a plan view of a state where a baffle, a diaphragm, and the diaphragm ring are made transparent in the electroacoustic transducing device in the embodiment of the invention.

FIG. 6 is a half-sectional view of the vibration system in the embodiment of the invention showing another use example of the diaphragm ring.

### MODE FOR CARRYING OUT THE INVENTION

Hereinafter, an embodiment of the invention will be described with reference to the drawings.

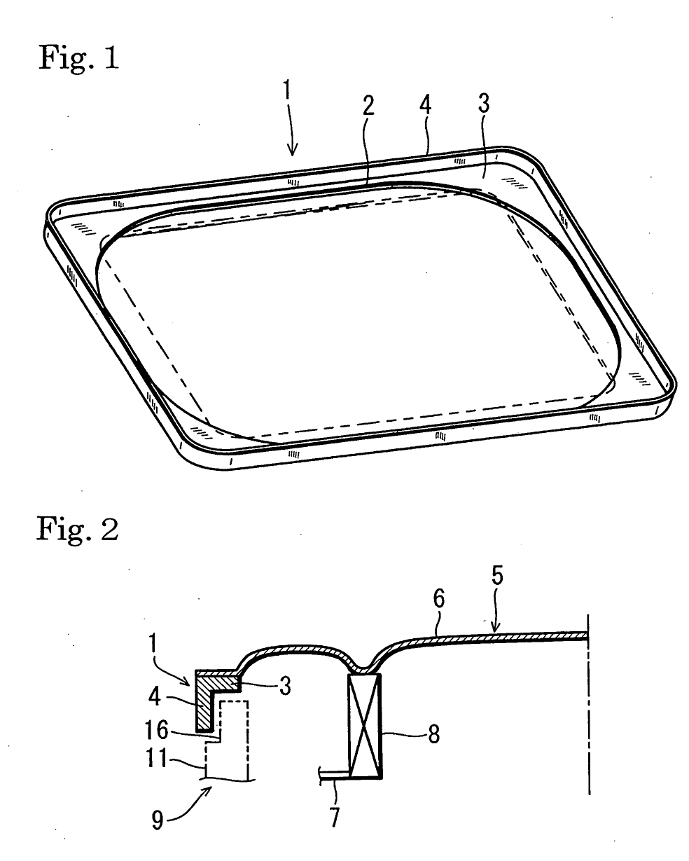

FIG. 1 is a perspective view of a diaphragm ring 1 in the embodiment. The diaphragm ring 1 is formed into a semi-finished product having a shallow bottomed rectangular tubular shape which is configured by applying a pressing process (a drawing process) on one sheet-like metal material, and then undergoes a punching process on a bottom portion of the semi-finished product to be formed as a finished product. The diaphragm ring has: a planar ring portion 3 which has an oval opening 2, the outer shape of which is rectangular, and which is placed in a plane perpendicular to the axis of a voice coil 8 that will be described later; and a wall portion 4 which is formed by bendingly extending the outer peripheral edge of the planar ring portion 3 at a bending angle of about 90 degrees in one direction. The diaphragm ring is formed into an L-like section shape.

FIG. 2 is a half-sectional view of a vibration system 5 which uses the diaphragm ring 1 shown in FIG. 1. In the vibration system 5, the diaphragm ring 1 is used in the form of an L-like section shape in which the wall portion 4 downward hangs from the outer peripheral edge of the planar ring portion 3. A diaphragm 6 which is made of a resin or metal film, and which has an oval outer shape is bonded to the upper face of the planar ring portion 3 that is in the uppermost portion of the diaphragm ring 1. The diaphragm 6 is bonded to an upper end portion of a rectangular tubular voice coil 8 formed by winding a conductor wire in which the outer surface is covered by an insulating layer. Two lead wires 7 which are winding start and end terminals, respectively are drawn out from a lower end portion of the voice coil 8.

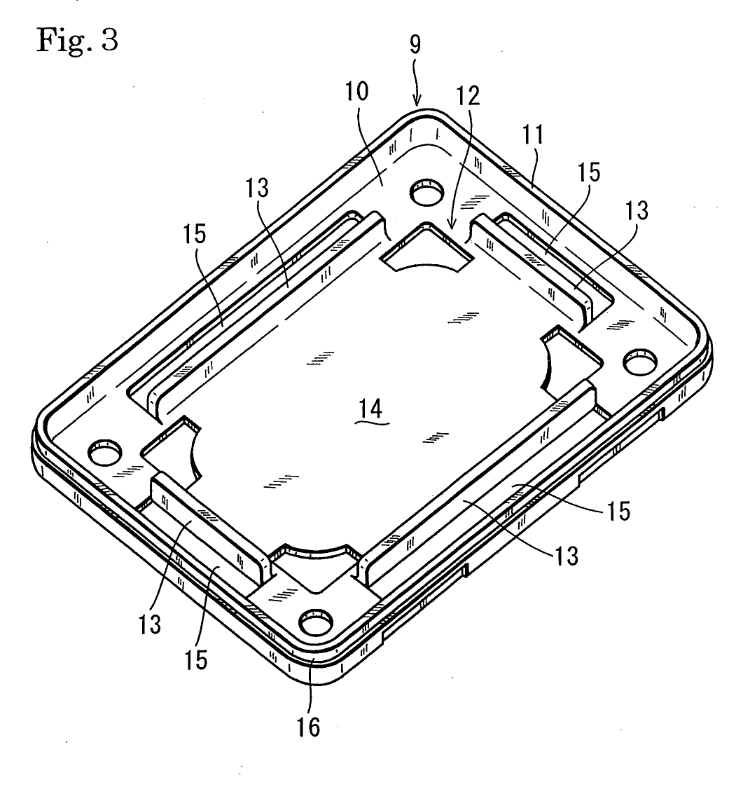

FIG. 3 is a perspective view of a frame 9 in the embodiment. The frame 9 is formed into a semi-finished product having a shallow bottomed rectangular tubular shape which is configured by applying a pressing process (a drawing process) on one sheet-like metal material, and in which a rectangular bottom plate 10 and a side wall 11 that is perpendicularly raised from the outer peripheral edge of the plate. Cutting and bending processes are performed on the bottom plate 10 to raise four outer side portions of the bottom plate 10, whereby a rectangular bottomed frame-like yoke portion 12 which is slightly smaller than the sidewall 11 is formed inside the sidewall 11. As a result, the frame is formed as a yoke-integral type.

The yoke portion 12 is configured by: four or front, rear, right, and left yoke sidewalls 13 which are opposed to the inside of the sidewall 11 across a predetermined space; and a rectangular yoke bottom plate 14 which is configured by a middle portion of the bottom plate 10 that is inside the yoke sidewalls 13. Openings 15 which are formed by raising the yoke sidewalls 13 from the bottom plate 10 are disposed in the outer sides of the yoke sidewalls 13.

A receiving face 16 for the diaphragm ring 1 is disposed in the frame 9. The receiving face 16 is disposed in an upper portion of the sidewall 11 of the frame 9, and supports from the lower side the lower face of the planar ring portion 3 of the diaphragm ring 1, by the upper end face of the sidewall 11 of the frame 9 in the state where the inner face of the wall portion 4 of the diaphragm ring 1 is contacted with the outer face of the sidewall 11 of the frame 9.

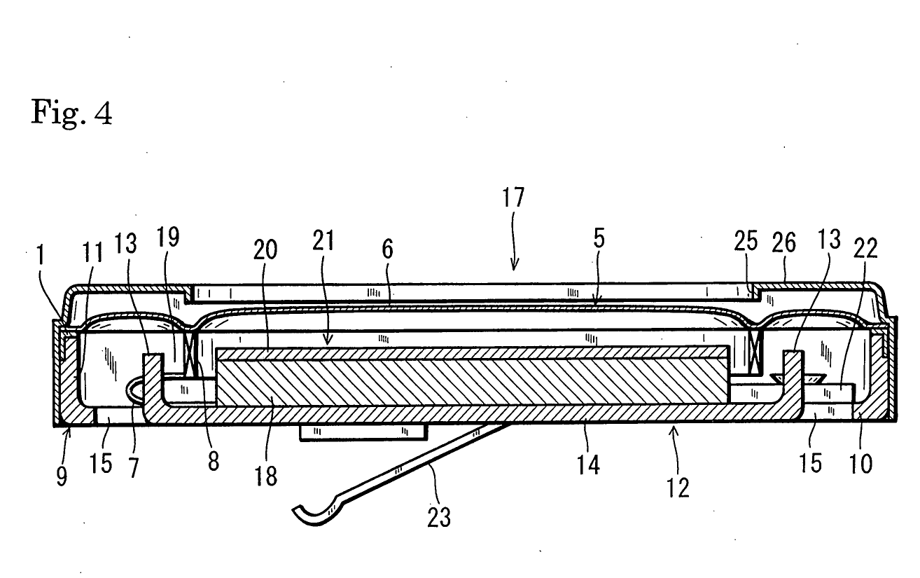

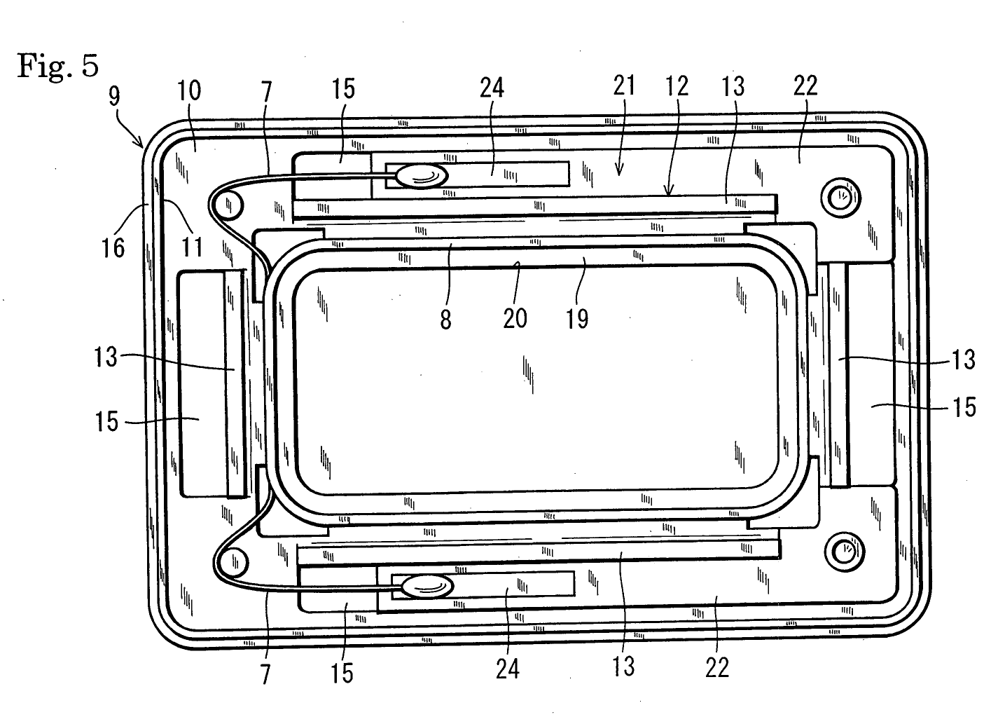

FIG. 4 is a mid-sectional view of a rectangular speaker (an example of the electroacoustic transducing device) 17 which is assembled by using the frame 9 shown FIG. 1, and FIG. 5 is a plan view of a state where a baffle, the diaphragm, and the diaphragm ring are made trans-parent in the speaker. In the speaker 17, a magnetic circuit 21 is configured by: the yoke portion 12 of the frame 9; a magnet 18 which is a rectangular columnar permanent magnet, and which is bonded and fixed onto the yoke bottom plate 14 of the yoke portion 12; and a pole piece 20 which is bonded and fixed onto the magnet 18, the outer face of which is opposed to the yoke sidewalls 13 of the yoke portion 12 across a magnetic gap 19, and which is configured by a rectangular metal plate.

External connection terminals 23 are disposed which are formed by applying punching and bending processes on a thin metal plate, and each of which a cantilever-like spring piece that is integrated with an insulating member 22 by insert molding. The external connection terminals 23 are fixed respectively to the two openings 15 of the long edge sides of the frame 9 through the insulating members 22, projected from the lower face of the frame 9 to the outside through the two openings 15 of the long edge sides, and embedded in the upper faces of the insulating members 22 while their one surfaces are exposed therefrom. Solder pads 24 which are conductive with the external connection terminals 23 are exposed from outer bottom portions of the two yoke sidewalls 13 of the long edge sides in the frame 9, through the two openings 15 of the long edge sides. The two openings 15 of the short edge sides are used as rear sound holes for the speaker 17.

The diaphragm ring 1 is fitted and fixed to the receiving face 16 disposed on the sidewall 11 of the frame 9, through an adhesive agent. An outer peripheral portion of the diaphragm 6 is bonded and fixed to that of the frame 9 through the diaphragm ring 1. The voice coil 8 is placed in the magnetic gap 19, and the magnetic circuit 21 and the vibration system 5 are coupled and integrated with each other by the frame 9, thereby completing the speaker. The two lead wires 7 which are drawn out from the lower portion of the voice coil 8 are laid in the frame 9 to be guided to the solder pads 24 to which the lead wires are to be connected, and then connected thereto by soldering, respectively. One sheet-like metal material undergoes a pressing process (a drawing process) to be formed into a roofed rectangular tubular semi-finished product. The semi-finished product undergoes a punching process to be formed as a product or a baffle 26 which has a front sound hole 25 for the speaker 17. The roofed rectangular tubular baffle 26, and the bottomed rectangular tubular frame 9 are fitted to each other, so that the front side of the diaphragm 6 is covered by the roof portion of the baffle 26 which has the front sound hole 25.

The thus configured speaker 17 is used in, for example, a portable telephone. When an electric audio signal is supplied from an external circuit to the voice coil 8 through the pair of external connection terminals 23, the interaction between the magnetic field generated in the magnetic circuit 21 and that generated as a result of the energization of the voice coil 8 causes the voice coil 8 to vertically vibrate, and, in accordance with this, the diaphragm 6 vertically vibrates to generate a sound.

According to the above-described embodiment, the diaphragm ring 1 has: the planar ring portion 3 which is placed in a plane perpendicular to the axis of the voice coil 8; and the wall portion 4 which is formed by bendingly extending the outer peripheral edge of the planar ring portion 3 at a bending angle of about 90 degrees in the downward direction, and the diaphragm ring is formed into an L-like section shape. Therefore, the diaphragm ring 1 is made thin, light in weight, and strong, and the speaker 17 can be easily thinned.

According to the diaphragm ring 1 having an L-like section shape, the inner shape of (the shape of the opening 2) can be changed while the outer shape of the planar ring portion 3 of the diaphragm ring 1 remains unchanged, and the diaphragm bonded face (the upper face of the planar ring portion 3) can be changed while the shape of the diaphragm bonded face (the upper face of the planar ring portion 3) can be changed while the shape of the face of the diaphragm ring 1 (the lower face of the planar ring portion 3 and the inner face of the wall portion 4) to be contacted with the receiving face 16 of the frame 9 remains unchanged. Therefore, variations can be provided to the shape of the diaphragm 6.

In the embodiment, the inner shape of the planar ring portion 3 of the diaphragm ring 1 is set to be oval in accordance with the shape (oval) of the diaphragm 6. As shown by the dash-dot-dot line in FIG. 1, alternatively, the inner shape may be changed to a rectangular shape which is slightly smaller than the outer shape of the planar ring portion 3, thereby enabling a rectangular diaphragm to be used.

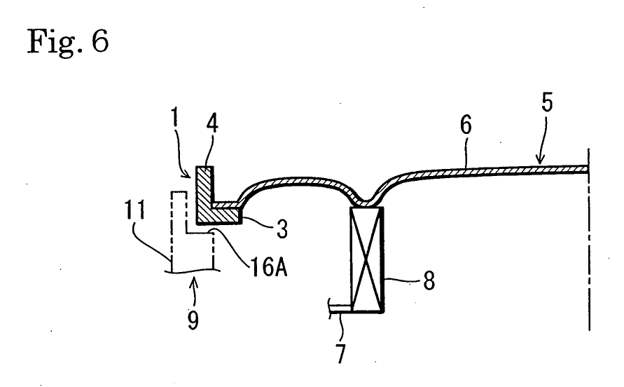

In the case where, as shown in FIG. 6, the frame 9 is provided with a receiving face 16A which supports from the lower side the lower face of the planar ring portion 3 of the diaphragm ring 1, by a stepped face of the inner face of the sidewall 11 of the frame 9 in the state where the outer face of the wall portion 4 of the diaphragm ring 1 is contacted with the inner face of the sidewall 11 of the frame 9, the diaphragm ring 1 may be vertically inverted, i.e., the diaphragm ring may be used in an L-like section shape in which an upward wall portion 4 is raised from the outer peripheral edge of the planar ring portion 3, and an outer peripheral portion of the diaphragm 6 may be bonded to the upper face of the planar ring portion 3. Also in this case, the inner shape (the shape of the opening 2) can be changed while the outer shape of the planar ring portion 3 of the diaphragm ring 1 remains unchanged, and the diaphragm bonded face (the upper face of the planar ring portion 3) can be changed while the shape of the face of the diaphragm ring 1 (the lower face of the planar ring portion 3 and the outer face of the wall portion 4) to be contacted with the receiving face 16A of the frame 9 remains unchanged. Therefore, variations can be provided to the shape of the diaphragm 6.

In the embodiment, the rectangular speaker 17 using the yoke-integral type rectangular frame 9 has been described as the electroacoustic transducing device of the invention. The invention may be applied also to a circular speaker using a yoke-integral type circular frame, a rectangular or circular speaker using a resin-made frame which is separated from the yoke, or a surface mount type speaker in which external connection terminals are exposed substantially flushly from the lower face of the speaker. The invention is not restricted to the above-described embodiment, and variously implemented without departing from the spirit of the invention.

### DESCRIPTION OF REFERENCE NUMERALS

1 diaphragm ring
2 opening
3 planar ring portion
4 wall portion
5 vibration system
6 diaphragm
8 voice coil
9 frame
12 yoke portion
16, 16A receiving face
18 magnet
19 magnetic gap
20 pole piece
21 magnetic circuit

What is claimed is:

1. An electroacoustic transducing device comprising: a magnetic circuit having a yoke, a magnet, and a pole piece; a vibration system having a diaphragm, a voice coil, and a diaphragm ring; and a frame which holds said magnetic circuit and said vibration system, an outer peripheral portion of said diaphragm being fixed to an outer peripheral portion of said frame through said diaphragm ring, said voice coil being placed in a magnetic gap, wherein said diaphragm ring has: a planar ring portion which is placed in a plane perpendicular to an axis of said voice coil; and a wall portion which is formed by bendingly extending an outer peripheral edge of said planar ring portion at a bending angle of about 90 degrees in one direction, and said diaphragm ring is formed into an L-like section shape.

2. An electroacoustic transducing device according to claim 1, wherein said diaphragm ring is formed by applying a pressing process on one sheet-like metal material.

3. An electroacoustic transducing device according to claim 1, wherein said frame is formed by applying a pressing process on one sheet-like metal material, and by, in the pressing process, integrally forming a yoke portion, whereby said frame is formed as a yoke-integral type frame.
